(19) United States
(12) Patent Application Publication
(10) Pub. No.: US 2011/0318095 A1
(43) Pub. Date: Dec. 29, 2011

(54) FURNITURE CONNECTOR AND FURNITURE UTILIZING SAME

(76) Inventor: Jocelyn Beaulieu, Newmarket (CA)

(21) Appl. No.: 12/821,262

(22) Filed: Jun. 23, 2010

(51) Int. Cl. F16B 9/00

(52) U.S. Cl. 403/230

(57) ABSTRACT

A furniture connector for connecting a first member having a longitudinal axis to a second member positioned transverse to the first member is disclosed. The second member has an interior passage in at least one end thereof and a hole communicating with the interior passage. The furniture connector includes a block, a flange, at least one first bore in the block, at least one first fastener, and at least one second bore in the block transverse to the first bore, and at least one second fastener. The block is removably received within the interior passage of the second member. The flange is secured to the block and abuts against the first member. The first bore extends through the block and the flange. The first fastener passes through the first bore and engages the first member. The first fastener removably secures the block to the first member. The second fastener passes through the hole in the second member and is received in the second bore. The second fastener resists separation of the block from the interior passage of the second member.

### FIELD

The invention relates to a connector for furniture and to furniture with members connected using the connector.

### INTRODUCTION

Easy to assemble and disassemble furniture pieces, such as chairs, are commercially desirable for certain applications and often utilize connectors which facilitate easy assembly and disassembly. Such furniture pieces are sometimes referred to as “knock down” furniture.

### SUMMARY

According to a first aspect of the invention, a furniture connector for connecting a first member having a longitudinal axis to a second member positioned transverse to the first member is provided. The second member has an interior passage in at least one end thereof and a hole communicating with the interior passage. The furniture connector comprises a block, a flange, at least one first bore in the block, at least one first fastener, and at least one second bore in the block transverse to the first bore, and at least one second fastener. The block is adapted to be removably received within the interior passage of the second member. The flange is secured to the block and abuts against the first member. The first bore extends through the block and the flange. The first fastener passes through the first bore and engages the first member. The first fastener removably secures the block to the first member. The second fastener passes through the hole in the second member and is received in the second bore. The second fastener resists separation of the block from the interior passage of the second member.

According to a second aspect of the invention, a furniture piece is provided, the furniture piece comprises

a) a first member defining at least one transverse hole therein, the first member defining a longitudinal axis;
b) a threaded insert secured within the transverse hole;
c) a second member positioned transverse to the first member, the second member defining an interior passage in at least one end of the second member and at least one hole communicating with the interior passage; and
d) a connector comprising:
i) a block adapted to be removably received within the interior passage of the second member;
ii) a flange secured to the block, the flange being adapted to abut against the first member;
iii) at least one first bore extending through the block and the flange;
iv) at least one first threaded fastener adapted to pass through the first bore and into the threaded insert, wherein the first fastener is adapted to be removably secured within the threaded insert, thereby removably securing the connector to the first member;
v) at least one second bore defined in the block, wherein the second bore is transverse to the first bore; and
vi) a second fastener adapted to pass through the hole in the second member and be received in the second bore, wherein the second fastener is adapted to resist separation of the block from the interior passage of the second member.

According to a third aspect of the invention, a chair is provided. The chair comprises:

a) at least one leg having a longitudinal axis defining a pair of transverse holes therein;
b) a pair of threaded inserts, wherein each threaded insert is secured within one of the pair of the transverse holes;
c) a seat support portion connected to a pair of substantially horizontal support members, each support member defining an interior passage therethrough and a pair of holes in the support member proximate to an end thereof, each of the pair of holes communicating with the interior passage; and
d) at least one connector comprising:
i) a block adapted to be removably received within the interior passage of the support member;
ii) a flange secured to the block, the flange being adapted to abut against the leg;
iii) a pair of first bores extending through the block and the flange;
iv) a pair of threaded first fasteners, wherein each first fastener is adapted to pass through the first bore and into one of the threaded inserts, wherein each first fastener is adapted to be removably secured within one of the threaded inserts, thereby removably securing the block to the leg;
v) a pair of threaded second bores defined in the block, wherein the second bores are transverse to the first bores; and
vi) a pair of second threaded fasteners, wherein each second adapted to pass through one of the pair of holes in the second member and be received in one of the pair second bores, wherein the second fasteners are adapted to resist separation of the block from the interior passage of the support member.

### DRAWINGS

For a better understanding of embodiments of the systems and methods described herein, and to show more clearly how they may be carried into effect, reference will be made, by way of example, to the accompanying drawings in which:

FIG. 1 is a bottom perspective view of a portion of a chair according to an embodiment of the present invention;

FIG. 2 is an exploded perspective view showing a furniture connector according to an embodiment of the present invention;

FIG. 2A is another exploded perspective view of the furniture connector of FIG. 2;

FIG. 3 is a perspective view showing the furniture connector of FIG. 2 connected to a leg of the chair;

FIG. 4 is another exploded perspective view showing the connection of the furniture connector of FIG. 2 to a support member;

FIG. 5 is a perspective view showing the leg connected to the support member using the furniture connector of FIG. 2.

### DESCRIPTION OF VARIOUS EMBODIMENTS

Various apparatuses or processes will be described below to provide an example of each claimed invention. No example described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. Applicant reserves the right to claim such apparatuses or processes in other applications.

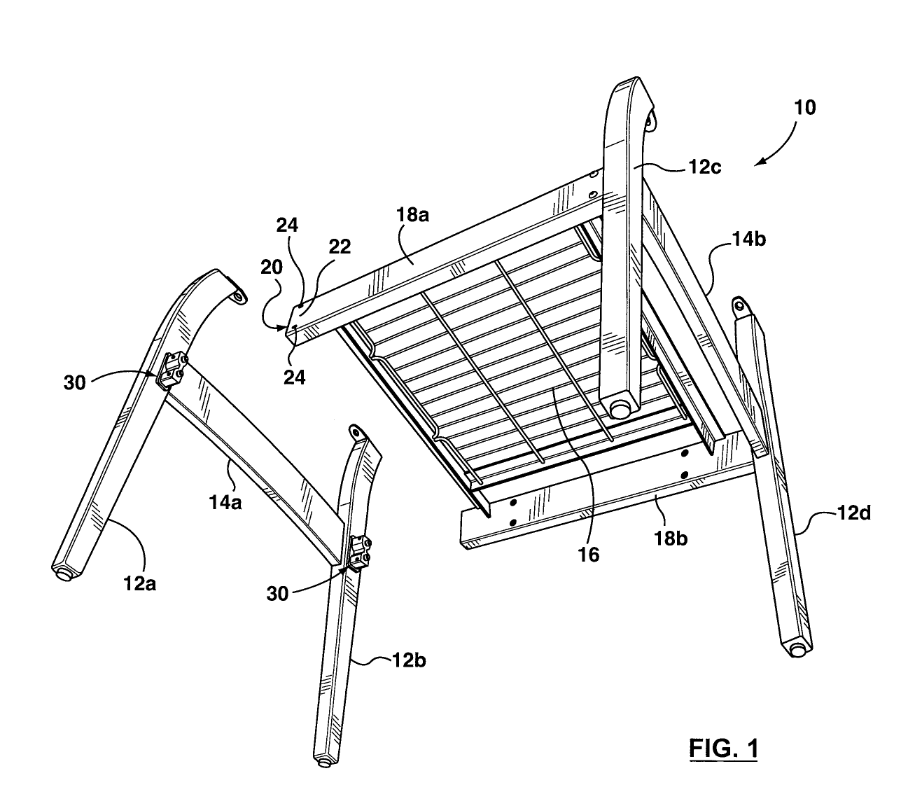

Referring to FIG. 1, a chair 10 is shown. It will be understood by those skilled in the art that embodiments of the present invention can be applied to any other type of furniture piece, such as a table, and can be used to connect any first member to any second member of a furniture piece.

For clarity, the seat, arm rests, and back support of the chair 10 are not illustrated in FIG. 1. The chair 10 includes preferably four first members, such as legs 12a-d. Each pair of legs 12a-b and 12c-d are secured to each other by connecting members 14a, 14b, respectively. The connecting members are secured to the legs by any suitable means, such as by tenon and mortise or dowels secured by an adhesive. Preferably, the legs 12a-d and connecting members 14a,b are made of wood, but could also be made from any other suitable material, such as molded plastics, cast aluminum, or steel.

Continuing to refer to FIG. 1, the chair 10 also includes a seat support portion 16 for supporting the seat (not shown). Preferably, the seat support portion is composed of a number of metal members in a row-wise and column-wise configuration. It will be understood by those skilled in the art will that the seat support portion may utilize any suitable suspension system, such as springs, elastic webbing, or mat webbing. The seat support portion is secured to a pair of second members, such as support members 18a, 18b. Preferably, the support members are also made of metal and are welded to the seat portion 16. The support members run along the front and rear edges of the seat portion 16. An interior passage 20 is provided at each end 22 of each support member 18a, 18b.

Continuing to refer to FIG. 1, support members 18a, 18b are preferably hollow members with a rectangular cross-section, and the interior passage 20 extends throughout the length of the support members 18a, 18b. Preferably, a pair of holes 24 are provided at each end 22 of each support member. The holes 24 extend into the interior passage 20.

Preferably, four connectors 30 connect each leg 12a-d to the ends 22 of each support member 18a,18b. Only two of the four connectors 30 are visible in FIG. 1.

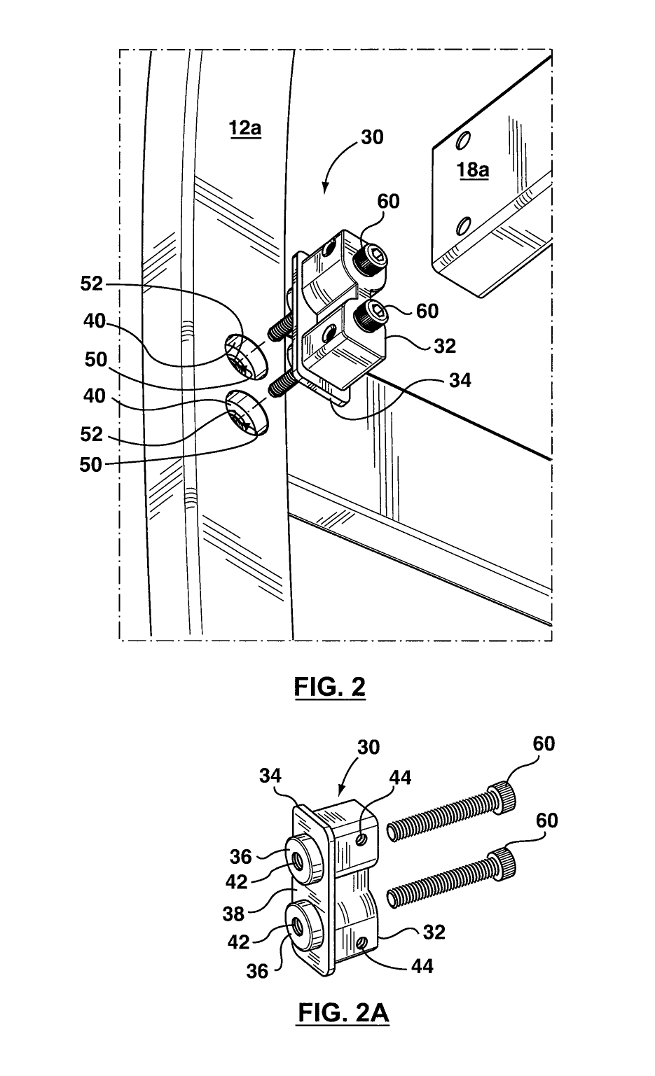

Referring now to FIGS. 2 and 2A, the connector 30 includes a block 32 having any suitable shape which fits snugly within the interior passage 20 of the support members 18a,b (only support member 18a is shown in FIG. 2). The block 32 is connected to a flange 34 which abuts the legs 12a-d (only leg 12a is shown in FIG. 2). A pair of preferably cylindrical bosses 36 project from a contact surface 38 of the flange 34. The bosses 36 are each received within a corresponding pair of preferably cylindrical recesses 40 in the leg 12a. A pair of first bores 42 extend through the block 32, flange 34, and each boss 36. A pair of preferably threaded second bores 44 extend through the block 32 and are oriented transversely to the first bores 42.

Continuing to refer to FIGS. 2 and 2A, a pair of transverse holes 50 extend into the legs 12a,b from each recess 40. The recesses 40 and transverse holes 50 are preferably made a by counterbore drill. Preferably, the transverse holes are aligned so that an imaginary line joining the transverse holes is parallel to a longitudinal axis of the leg. A threaded insert 52 is secured in each transverse hole 50 preferably using a socket cap screw driving tool. Preferably, the entire length of the threaded insert is located in the transverse hole such that the end of the threaded insert is below or flush with the surface of the recess 40. Each threaded insert 52 receives one of a pair of first fasteners, such as bolts 60. Each bolt 60 passes through the corresponding first bore 42.

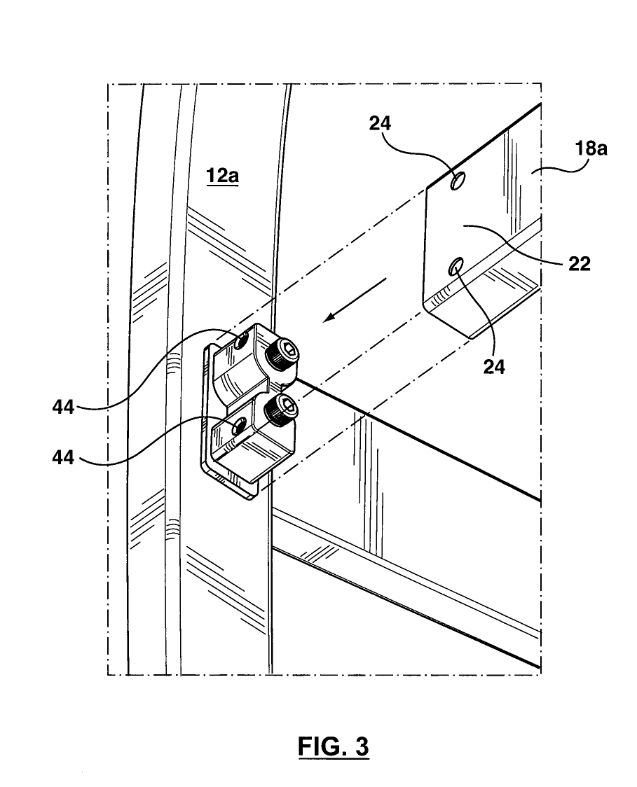

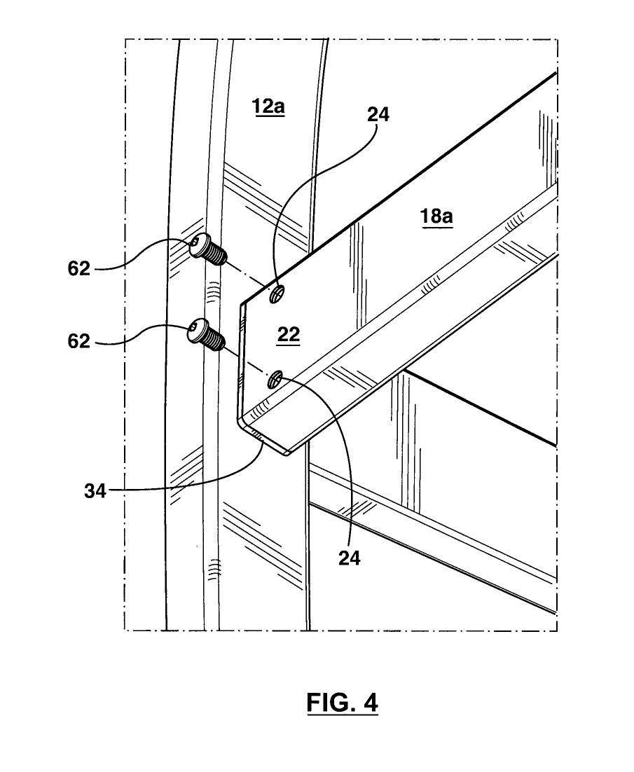

Referring now to FIGS. 3 and 4, each second bore 44 receives one of a pair of second fasteners, such as screws 62. The screws pass through the holes 24 in the end 22 of support member 18a.

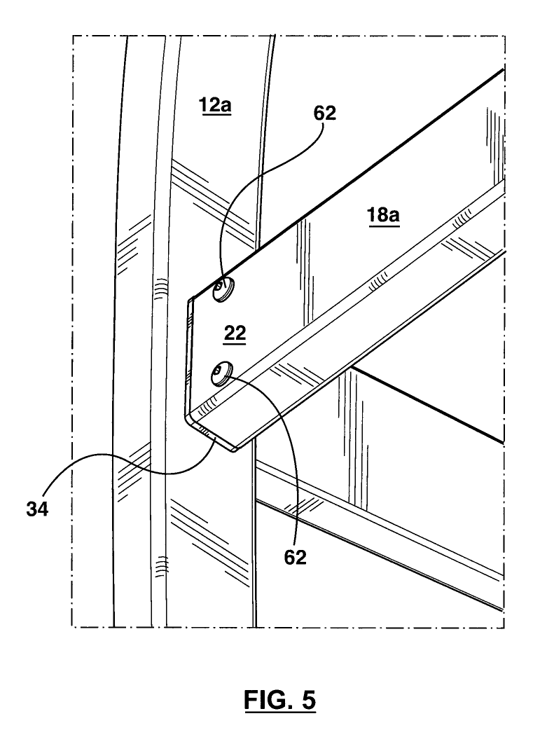

The operation of the preferred embodiment of the present invention will now be described with reference to FIGS. 1-5. In order to assemble the seat portion 16 of the chair 10 to the legs 12a-d. The contact surface 38 of first connector 30 is placed against the leg 12a such that the bosses 36 are received within the recesses 40 of the leg 12a. The bolts 60 are then inserted through the first bores in the connector 30 and are received in the threaded inserts 52. The connector 30 is then secured to the leg 12a by tightening the bolts 60 in the threaded inserts 52, preferably using an alien key. Preferably, the bolts 60 are hexagonal flange bolts or socket cap screws. A second connector 30 is preferably secured to the leg 12b in the same manner as described above. The assembly consisting of pair of legs 12a,b connected by connecting member 14a is then secured to the seat portion 16 by inserting the block 32 of the two connectors 30 into the interior passage 20 of support members 18a and 18b (best shown in FIGS. 3 and 4). To prevent separation of the block 32 from support member 18a, two screws 62 are passed through the holes 24 in the support member 18a and received in the second threaded bores 44 of the block 32. The connector 30 is secured to the support member 18a by tightening the screws 62, preferably using an alien key. The connector 30 is secured to the support member 18b in a similar fashion. To complete assembly, legs 12c,d are secured to support members 18a,b in the same manner as described above (using the third and fourth connectors 30). The assembly of the chair 10 may be completed by attaching the seat, back rest, and arm rests (not shown) in any suitable fashion

In order to disassemble the seat portion 16 from the legs 12a-d, the screws 62 are removed to permit removal of the seat portion 16. The connectors 30 are then removed from each of the legs 12a-d by removing the bolts 60.

The connector and chair of the embodiment described herein facilitates easy assembly and disassembly of furniture while providing improved resistance to lateral, shear, moment, and compressive forces, as well as providing a pleasing aesthetic appearance.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A furniture connector for connecting a first member having a longitudinal axis to a second member positioned transverse to the first member, the second member having an interior passage in at least one end thereof and a hole communicating with the interior passage, the furniture connector comprising:
a) a block adapted to be removably received within the interior passage of the second member;
b) a flange secured to the block, the flange being adapted to abut against the first member;
c) at least one first bore extending through the block and the flange;
d) at least one first fastener adapted to pass through the first bore and engage the first member, wherein the at least one first fastener is adapted to removably secure the block to the first member;
e) at least one second bore defined in the block, wherein the second bore is transverse to the first bore; and
f) at least one second fastener adapted to pass through the hole in the second member and be received in the second bore, wherein the second fastener is adapted to resist separation of the block from the interior passage of the second member.

2. The furniture connector of claim 1, further comprising at least one threaded insert secured within a transverse hole in the first member, wherein the first fastener is threaded and is adapted to be removably secured to the first member by threadable engagement with the threaded insert.

3. The furniture connector of claim 2, further comprising at least one boss projecting from a contact surface of the flange, wherein the contact surface abuts against the first member, wherein the at least one boss is received in a recess defined in the first member, wherein the transverse hole extends into the first member from the recess.

4. The furniture connector of claim 3, further comprising a pair of the first fasteners and a pair of the bosses, wherein the pair of the first fasteners are adapted to pass through a pair of the first bores and are adapted to be secured in a pair of the threaded inserts, wherein the pair of the bosses is received in a pair of recesses in the first member.

5. The furniture connector of claim 4, wherein the pair of the first fasteners is aligned generally parallel to the longitudinal axis of the first member.

6. The furniture connector of claim 5, wherein the first fastener is a bolt.

7. The furniture connector of claim 6, wherein the second fastener is threaded and the second bore in the block is threaded, wherein the second fastener is adapted to threadably secure the second member to the block.

8. A furniture piece comprising:
a) a first member defining at least one transverse hole therein, the first member defining a longitudinal axis;
b) a threaded insert secured within the transverse hole;
c) a second member positioned transverse to the first member, the second member defining an interior passage in at least one end of the second member and at least one hole communicating with the interior passage; and
d) a connector comprising:
i) a block adapted to be removably received within the interior passage of the second member;
ii) a flange secured to the block, the flange being adapted to abut against the first member;
iii) at least one first bore extending through the block and the flange;
iv) at least one first threaded fastener adapted to pass through the first bore and into the threaded insert, wherein the first fastener is adapted to be removably secured within the threaded insert, thereby removably securing the connector to the first member;
v) at least one second bore defined in the block, wherein the second bore is transverse to the first bore; and
vi) a second fastener adapted to pass through the hole in the second member and be received in the second bore, wherein the second fastener is adapted to resist separation of the block from the interior passage of the second member.

9. The furniture piece of claim 8, further comprising at least one boss projecting from a contact surface of the flange, wherein the contact surface abuts against the first member, wherein the at least one boss is received in a recess defined in the first member, wherein the transverse hole extends into the first member from the recess.

10. The furniture piece of claim 9, further comprising a pair of the first fasteners and a pair of the bosses, wherein the pair of the first fasteners are adapted to pass through a pair of the first bores and are adapted to be secured in a pair of the threaded inserts, wherein the pair of the bosses is received in a pair of recesses in the first member.

11. The furniture piece of claim 10, wherein the pair of the first fasteners is aligned generally parallel to the longitudinal axis of the first member.

12. The furniture piece of claim 11, wherein the first fastener is a bolt.

13. The furniture piece of claim 11, wherein the second fastener is threaded and the second bore in the block is threaded, wherein the second fastener is adapted to threadably secure the second member to the block.

14. The furniture piece of claim 11, wherein the second member is hollow and the interior passage extends longitudinally through the entire second member.

15. The furniture piece of claim 14, wherein the first member is a leg positioned substantially vertically and the second member is positioned substantially horizontally.

16. The furniture piece of claim 15, wherein the furniture piece is a chair.

17. The furniture piece of claim 16, wherein the second member is connected to a seat support portion.

18. The furniture piece of claim 15, further comprising four legs, four of the connectors and a pair of the second members, wherein one of the four legs is connected to each end of each second member by one of the four connectors.

19. A chair comprising:
a) at least one leg having a longitudinal axis defining a pair of transverse holes therein;
b) a pair of threaded inserts, wherein each threaded insert is secured within one of the pair of the transverse holes;
c) a seat support portion connected to a pair of substantially horizontal support members, each support member defining an interior passage therethrough and a pair of holes in the support member proximate to an end thereof, each of the pair of holes communicating with the interior passage; and
d) at least one connector comprising:
i) a block adapted to be removably received within the interior passage of the support member;
ii) a flange secured to the block, the flange being adapted to abut against the leg;
iii) a pair of first bores extending through the block and the flange;
iv) a pair of threaded first fasteners, wherein each first fastener is adapted to pass through the first bore and into one of the threaded inserts, wherein each first fastener is adapted to be removably secured within one of the threaded inserts, thereby removably securing the block to the leg;
v) a pair of threaded second bores defined in the block, wherein the second bores are transverse to the first bores; and
vi) a pair of second threaded fasteners, wherein each second adapted to pass through one of the pair of holes in the second member and be received in one of the pair second bores, wherein the second fasteners are adapted to resist separation of the block from the interior passage of the support member.

20. The chair of claim 19, further comprising a pair of bosses projecting from a contact surface of the flange, wherein the contact surface abuts against the first member, wherein the each of the bosses is received in on one of a pair of recesses defined in the first member, wherein each transverse hole extends into the first member one of the pair of recesses.
